(19) United States
(12) Patent Application Publication
(10) Pub. No.: US 2009/0267888 A1
(43) Pub. Date: Oct. 29, 2009

(54) OVERDRIVING APPARATUS AND METHOD THEREOF

(75) Inventor: Jui-Lin Lo, Tainan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 12/134,209

(22) Filed: Jun. 6, 2008

(30) Foreign Application Priority Data
Apr. 25, 2008 (TW) 97115365

(51) Int. Cl. G09G 3/36

(52) U.S. Cl. 345/101

(57) ABSTRACT

An overdriving apparatus and an overdriving method for a liquid crystal display (LCD) panel are disclosed. The overdriving apparatus includes a temperature measuring apparatus and an overdriving signal generator apparatus. The temperature measuring apparatus is coupled to the overdriving signal generator apparatus. The temperature measuring apparatus measures an operation temperature of the LCD panel. The overdriving signal generator apparatus generates a first overdriving signal according to a first image data of a current frame, x second image data of previous x frame(s), and the operation temperature, where x is a natural number.

### CROSS-REFERENCE TO RELATED APPLICATION

This application claims the priority benefit of Taiwan application serial no. 97115365, filed on Apr. 25, 2008. The entirety of the above-mentioned patent application is hereby incorporated by reference herein and made a part of specification.

### BACKGROUND OF THE INVENTION

1. Field of the Invention

The present invention generally relates to an overdriving apparatus adapted for a display system, and a method thereof, and more particularly, to an overdriving apparatus for providing a compensation for the temperature influence.

2. Description of Related Art

Liquid crystal displays (LCD) have progressively replaced the conventional cathode ray tube (CRT) displays, because of their advantageous features such as smaller volume and lower power consumption. LCDs are employed in various kinds of products, from a small-sized panel for a cell phone screen to a large-sized for the television set and advertising viewing board. However, when displaying dynamic images, the response speed of liquid crystal units of LCDs is generally too slow. Therefore, there are often motion artifact or blurred images when an LCD displaying moving images, such artifacts will seriously deteriorate the displayed image quality.

Currently, over-driving method is widely adopted to improve the response speed of the liquid crystal units. By enhancing the changing pixels values between frames, the quality of the dynamic images can be improved, and the image artifacts can be effectively eliminated.

FIG. 1 is a circuit diagram of a conventional overdriving apparatus 100. Referring to FIG. 1, the overdriving apparatus 100 includes a frame memory 10, an overdriving signal generator 11. The overdriving signal generator 11 is coupled with the frame memory 10 and a display apparatus 12.

Generally, a first drive stage of the display apparatus 12 is typically a source driver circuit. In other words, the overdriving signal generator 11 will generate an overdriving signal Drv_Out and provide the overdriving signal Drv_Out to the source driver circuit. The source driver circuit then amplifies the overdriving signal Drv_Out, and transmits the amplified overdriving signal Drv_Out to an LCD panel of the display apparatus 12.

As shown in FIG. 1, the frame memory 10 records image data Pre_Data of several previous frames (usually no more than previous 3 frames otherwise it will be too costly), and outputs the image data Pre_Data to the overdriving signal generator 11. The image data represents the pixel values of the image, which usually includes their red component, green component and blue component. The overdriving signal generator 11 receives the image data Pre_Data of the previous frames from the frame memory 10 and image data Cur_Data of the current frame, and generates the overdriving signal Drv_Out according to the image data Pre_Data of the previous frames and the image data Cur_Data of the current frame.

In a simplest and typical design, the frame memory 10 stores the image data Pre-Data of only one previous frame, and the overdriving signal generator 11 generates the overdriving signal Drv_Out according to the image data Pre_Data of the only one previous frame and the image data Cur_Data of the current frame.

The overdriving signal generator 11 may be realized with a lookup table or a calculation circuit. For example, with a lookup table, the overdriving signal generator 11 takes the image data Pre_Data of the previous frame from the frame memory and the image data Cur_Data the current frame as indices to refer to the lookup table to generate the driving signal Drv_Out. The signal value of the overdriving signal Drv_Out is carefully designed to improve the response speed of liquid crystal molecules. In such a way, the quality of the LCD screen for dynamic images can be improved, and the image artifacts can be reduced.

FIG. 2 shows a portion of a lookup table of the overdriving signal generator. Referring to FIG. 2, when a pixel value of the image data Pre_Data of the previous frame is 36, while the pixel value of the image data Cur_Data of the current frame is 68, the resulted pixel value of the overdriving signal Drv_Out outputted by the overdriving signal generator 11 is 71.

When the overdriving signal generator 11 is realized with such a lookup table, the lookup table's indices are usually multiples of 4 or 8. As in the present example, the lookup table records indices are multiples of 4 only, and when the image values (either Pre_Data or Cur_Data) are not multiples of 4, the output values of the overdriving signal Drv_Out can be obtained by a dual interpolation.

For example, when a pixel value of the image data Pre_Data of the previous frame is 34, while a pixel value of the image data Cur_Data of the current frame is 66, the pixel value of the overdriving signal Drv_Out can be obtained by interpolation. At first, a pixel value of an overdriving signal Temp_{—}1 is calculated in accordance with the image data of a previous frame having a pixel value 32 and the image data of a current frame having a pixel value of 66, in which Temp_{—}1=(73−70)/4*(66−64)+70=71.5. Then, a pixel value of an overdriving signal Temp_{—}2 is calculated in accordance with the image data of a previous frame having a pixel value 36 and the image data of a current frame having a pixel value of 66, in which Temp_{—}1=(71−68)/4*(66−64)+70=69.5. Finally, by the interpolation with the signal values Temp_{—}2 and Temp_{—}1, a signal value Temp_{—}3 corresponding to a previous frame having a pixel value 34 and the image data of a current frame having a pixel value of 66, in which Temp_{—}3=(71.5−69.5)/4*(36−34)+69.5=70.5.

Although the aforementioned conventional overdriving apparatus has a simple structure, it ignores the temperature influence to a light transmittance control apparatus of the panel. For example, the liquid crystal molecules can be considered as a light transmittance control apparatus. The viscosity and the refractive indices of the liquid crystal molecules affect the transmittance and the response speed of the liquid crystal molecules, and meanwhile the viscosity and the refractive indices of the liquid crystal molecules vary according to the temperature.

In consequence, the conventional overdriving method is not suitable for a wide range of temperature, and an overdriving signal which is optimal for a particular temperature would be undershoot or overshoot for different temperature. In a conventional overdriving method, the undershoot overdriving signal will result in too slow response speed and motion blur. In contrast, the overshoot overdriving signal will result in too fast response speed and false double edge. Therefore, the conventional overdriving signal generator may be affected by temperature variation, which leads to impacts on the display quality of the LCD apparatus.

### SUMMARY OF THE INVENTION

Accordingly, the present invention discloses an overdriving apparatus for a liquid crystal display (LCD) panel. The overdriving apparatus is adapted to generate an overdriving signal, which is adapted for providing a compensation corresponding to temperature influence.

The present invention further discloses an overdriving method for an LCD panel. The overdriving method is adapted to generate an overdriving signal, which is adapted for providing a compensation corresponding to temperature.

The present invention provides an overdriving apparatus for an LCD panel. The overdriving apparatus includes a temperature measuring apparatus and an overdriving signal generator. The temperature measuring apparatus is coupled to the overdriving signal generator. The temperature measuring apparatus is adapted for measuring an operation temperature of the LCD panel. The overdriving signal generator is adapted for generating a first overdriving signal according to a first image data of a current frame, x second image data of previous x frame(s), and the operation temperature, where x is a natural number.

According to an embodiment of the present invention, the foregoing overdriving apparatus further includes a frame memory. The frame memory is coupled to the overdriving signal generator for storing the x second image data.

According to an embodiment of the present invention, the foregoing temperature measuring apparatus is a temperature sensor capable of sensing the operation temperature of the LCD panel or a temperature estimator for estimating a temperature of the LCD panel. The temperature measuring apparatus is mounted on or close to the LCD panel.

According to an embodiment of the present invention, the foregoing overdriving signal generator further may include a lookup table. The lookup table is adapted for recording the first overdriving signal in according to the first image data, the x second image data, and the operation temperature.

According to an embodiment of the present invention, the foregoing overdriving signal generator may include a calculation circuit. The calculation circuit is adapted for obtaining the first overdriving signal by calculating with the first image data, the x second image data, and the operation temperature.

The present invention further provides an overdriving method for an LCD panel. The overdriving method includes the steps of: (a) measuring or estimating an operation temperature of the LCD panel; (b) generating a first overdriving signal according to a first image data of a current frame, x second image data of previous x frame(s), and the operation temperature, in which x is a natural number.

According to an embodiment of the present invention, the overdriving method further includes a step: (c) storing the x second image data.

According to an embodiment of the present invention, the operation temperature of the LCD panel is obtained by measuring or estimating by a temperature sensor or a temperature estimator which is mounted on or close to the LCD panel.

According to an embodiment of the present invention, the step of generating first overdriving signal includes the steps of: (d) providing a lookup table, recording a the first overdriving signal according to the first image data, the x second image data, the operation temperature, and (e) looking up the lookup table to find out the first overdriving signal according to the first image data, the x second image data, and the operation temperature.

According to an embodiment of the present invention, the step of generating first overdriving signal includes the steps of: (f) providing a calculation circuit, adapted for obtaining the first overdriving signal by calculating with the first image data, the x second image data, and the operation temperature.

The overdriving apparatus and the overdriving method according to the present invention take the light transmittance varying according to temperature change into consideration (e.g., the viscosity and the refractive indices of liquid crystal molecules change by temperature variation so as to affect a response speed and the light transmittance of liquid crystal unit). It provides a temperature compensation to the generated overdriving signal. Therefore, the overdriving signal generator and the overdriving method in the present invention are adapted to provide better overdriving signals in wider temperatures range. The resulted over-driving signal won't be over-emphasized or under-emphasized. Compared to the conventional overdriving apparatus and the overdriving method thereof, an LCD employing the overdriving apparatus and the overdriving method according to the present invention can effectively eliminate the motion blur and double edge defects under temperature influence.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of a conventional overdriving apparatus 100.

FIG. 2 shows a portion of a lookup table of the overdriving signal generator 11.

FIG. 3 is a circuit diagram of an overdriving apparatus 300 according to an embodiment of the present invention.

FIG. 4A is a circuit diagram of an overdriving apparatus 400 according to an embodiment of the present invention.

FIG. 4B shows a part of content of a lookup table 35 of the overdriving signal generator 32.

FIG. 5A is a circuit diagram of an overdriving apparatus 500 according to an embodiment of the present invention.

FIG. 5B is a circuit diagram of an overdriving apparatus 510 according to an embodiment of the present invention.

FIG. 6A is a circuit diagram of an overdriving apparatus 600 according to an embodiment of the present invention.

FIG. 6B shows a portion of a lookup table 61 of the overdriving signal generator 32.

FIG. 7 is a flow chart illustrating an overdriving method according to an embodiment of the present invention.

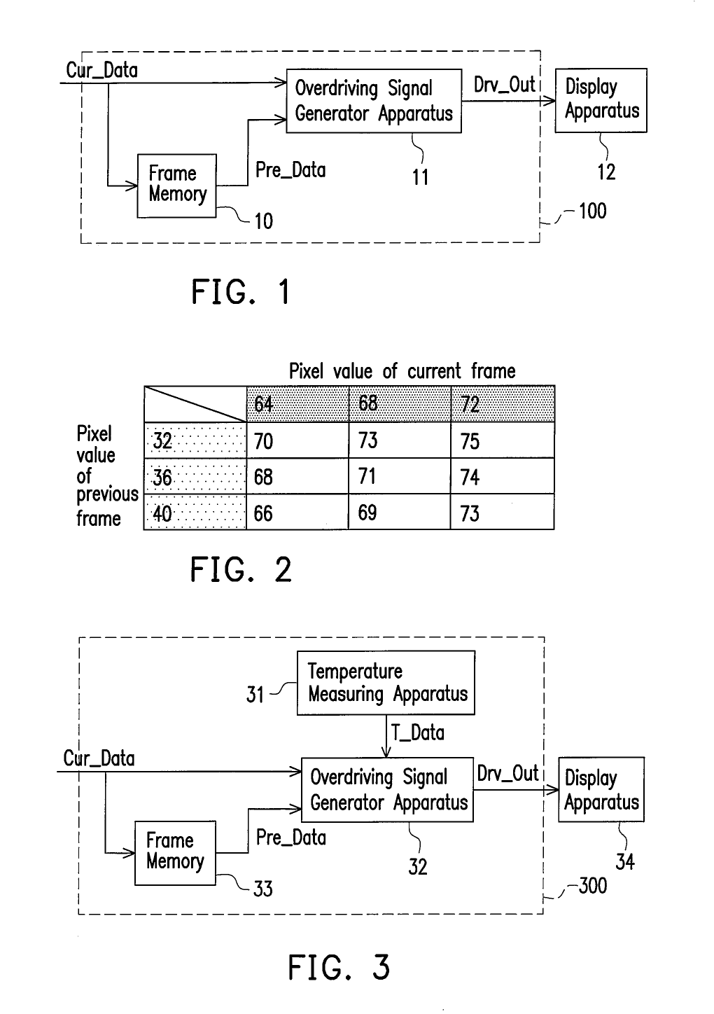

### DESCRIPTION OF THE EMBODIMENTS

The present invention provides an overdriving apparatus and an overdriving method for a liquid crystal display (LCD) panel. The overdriving apparatus and the overdriving method are adapted for generating an overdriving signal in according to temperature variation, and therefore capable of providing a compensation corresponding to the temperature influence. Reference will now be made in detail to the present preferred embodiments of the invention, examples of which are illustrated in the accompanying drawings. Wherever possible, the same reference counting numbers are used in the drawings and the description to refer to the same or like parts.

FIG. 3 is a circuit diagram of an overdriving apparatus 300 according to an embodiment of the present invention. The overdriving apparatus 300 includes a temperature measuring apparatus 31, an overdriving signal generator 32, and a frame memory 33. The temperature measuring apparatus 31 is coupled to the overdriving signal generator 32. The frame memory 33 is coupled to the overdriving signal generator 32. The overdriving signal generator 32 is coupled with a display apparatus 34.

Generally, a first drive stage of the display apparatus 34 is typically a source driver circuit. In other words, the overdriving signal generator 32 generates a first overdriving signal Drv_Out and provides the first overdriving signal Drv_Out to the source driver circuit. The source driver circuit then amplifies the first overdriving signal Drv_Out, and transmits the amplified first overdriving signal Drv_Out to an LCD panel of the display apparatus 34.

The frame memory is used for storing x second image data Pre_Data of previous x frames, where x is a natural number. The temperature measuring apparatus 31 is adapted for measuring an operation temperature T_Data of the LCD panel. The overdriving signal generator 32 is adapted to generate the first overdriving signal Drv_Out according to a first image data Cur_Data of a current frame, x second image data Pre_Data of previous x frame(s), and the operation temperature T_Data.

The temperature measuring apparatus 31 is a temperature sensor or a temperature estimator. The temperature sensor is mounted on or close to the LCD panel for sensing a temperature of the liquid crystal unit. The temperature measuring apparatus 31 is thus adapted for obtaining the operation temperature by either directly sensing or indirectly estimating the temperature of the light transmittance control unit.

Further, the temperature estimator is adapted to calculate an operation time of the LCD panel and estimate the operation temperature T_Data according to the operation time. In other words, when a relationship between the operation temperature T_Data and the operation time of the LCD panel is pre-determined, the temperature measuring apparatus 31 can be a temperature estimator, and the operation temperature T_Data outputted by the temperature estimator can serve as an estimated value of the temperature of the light transmittance control unit.

When considering the cost, there would be at most 3 second image data Pre-Data of previous 3 frames stored in the frame memory 33. The overdriving signal generator 32 generates the first overdriving signal Drv_Out according to the first image data Cur_Data of the current frame, the x second image data Pre_Data of the x previous frame(s), and the operation temperature T_Data. According to an simplest design of an embodiment of the present invention, the frame memory 33 stores only one second image data Pre_Data of the previous one frame, and the overdriving signal generator 32 generates the first overdriving signal Drv_Out according to the first image data Cur_Data of the current frame, the second image data Pre_Data of the previous frame, and the operation temperature T_Data.

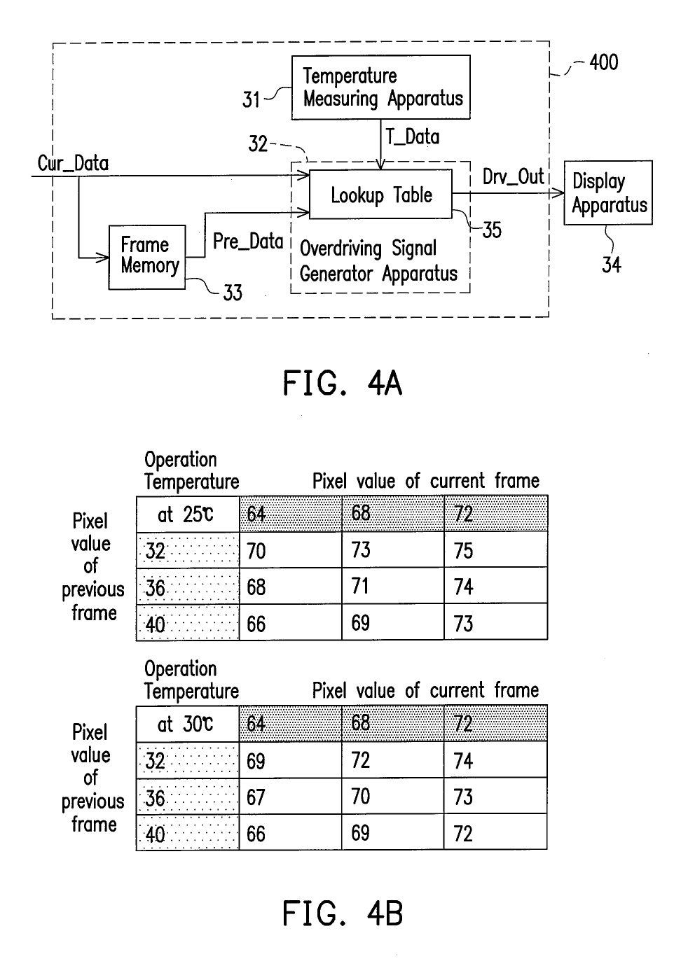

FIG. 4A is a circuit diagram of an overdriving apparatus 400 according to an embodiment of the present invention. Referring to FIG. 4A, the overdriving apparatus 400 includes an overdriving signal generator 32 having a lookup table 35. The lookup table 35 records the first overdriving signal Drv_Out in response to the operation temperature T_Data, the first image data Cur_Data, the x second image data Pre_Data. The first overdriving signal Drv_Out can be obtained by referring to the lookup table according to the first image data Cur_Data, the x second image data Pre_Data, and the operation temperature T_Data.

FIG. 4B shows a portion of a lookup table 35 of the overdriving signal generator 32. According to the embodiment, in order to save storage space, as shown in FIG. 4B, the lookup table 35 refers to the second image data Pre_Data of just one previous frame. In other words, in this embodiment, x=1. Further, according to the present embodiment, the lookup table 35 records first overdriving signals Drv_Out in according to the first image data Cur_Data and the second image data Pre_Data. Both image data values Cur_Data and Pre_Data are multiples of 4, operation temperatures which are multiples of 5° C. However, the method of looking up the lookup table 35 does not restrict the scope of the present invention. Further, typically, the operation temperature T_Data of an LCD panel is within a range of 0 to 70° C. As the result, the lookup table 35 is preferred to record operation temperatures T_Data within the range of 0 to 70° C.

However, if one of the first image data Cur_Data and the second image data Pre_Data is not a multiple of 4, or the operation temperature T_Data is not a multiple of 5, the first overdriving signal Drv_Out can be obtained by repetitively interpolation. Referring to FIG. 4B, for example if pixel values of the first image data Cur_Data and the second image data Pre_Data are 68 and 36 respectively, and the operation temperature T_Data is 25° C., then the corresponding first overdriving signal Drv_Out is 71. And if the pixel values of the first image data Cur_Data and the second image data Pre_Data are 68 and 36 respectively, and the operation temperature T_Data is 30° C., then the corresponding first overdriving signal Drv_Out is 70.

Further, if the pixel values of the first image data Cur_Data and the second image data Pre_Data are 66 and 34 respectively, and the operation temperature T_Data is 25° C., then the first overdriving signal Drv_Out can be obtained by interpolation. The first overdriving signal Temp_{—}1 is calculated according to the pixel values of the first image data Cur_Data and the second image data Pre_Data which are 66 and 32 respectively, and the operation temperature T_Data which is 25° C., in which Temp_{—}1=(73−70)/4*(68−66)+70=71.5. Then, a first overdriving signal Temp_{—}2 is calculated according to the pixel values of the first image data Cur_Data and the second image data Pre_Data which are 66 and 36 respectively, and the operation temperature T_Data which is 25° C., in which Temp_{—}2=(71−68)/4*(68−66)+68=69.5. Finally, the first overdriving signals Temp_{—}1 and Temp_{—}2 are used for calculating the first overdriving signal Drv_Out corresponding to a first image data and a second image data having pixel values of 66, 34 respectively with an operation temperature T_Data of 25° C., in which Drv_Out=(71.5−69.5)/4*(36−34)+69.5=70.5.

In the similar way, if the pixel values of the first image data Cur_Data and the second image data Pre_Data are 72 and 32 respectively, and the operation temperature T_Data is 27.5° C., then the first overdriving signal Drv_Out can also be obtained by interpolation. First overdriving signal Temp_{—}1 is calculated according to the pixel values 72 and 32 respectively of the first image data Cur_Data and the second image data Pre_Data, with an operation temperature T_Data of 25° C., in which Temp_{—}1=75. Then, a first overdriving signal Temp_{—}2 is calculated according to the pixel values 72 and 32 respectively of the first image data Cur_Data and the second image data Pre-Data, with an operation temperature T_Data of 30° C., in which Temp_{—}1=74. Then, the first overdriving signals Temp_{—}1 and Temp_{—}2 are used for calculating the first overdriving signal Drv_Out corresponding to a first image data and a second image data having pixel values of 72, 32 respectively and the operation temperature T_Data of 27.5° C, where Drv_Out=(75−74)/5*(27.5−25)+74=74.5.

The method for obtaining the first overdriving signal Drv_Out by the lookup table 35 and the interpolation method has been illustrated in details above. However, the above-illustrated embodiments are for illustration only and are not for restricting the scope of the present invention.

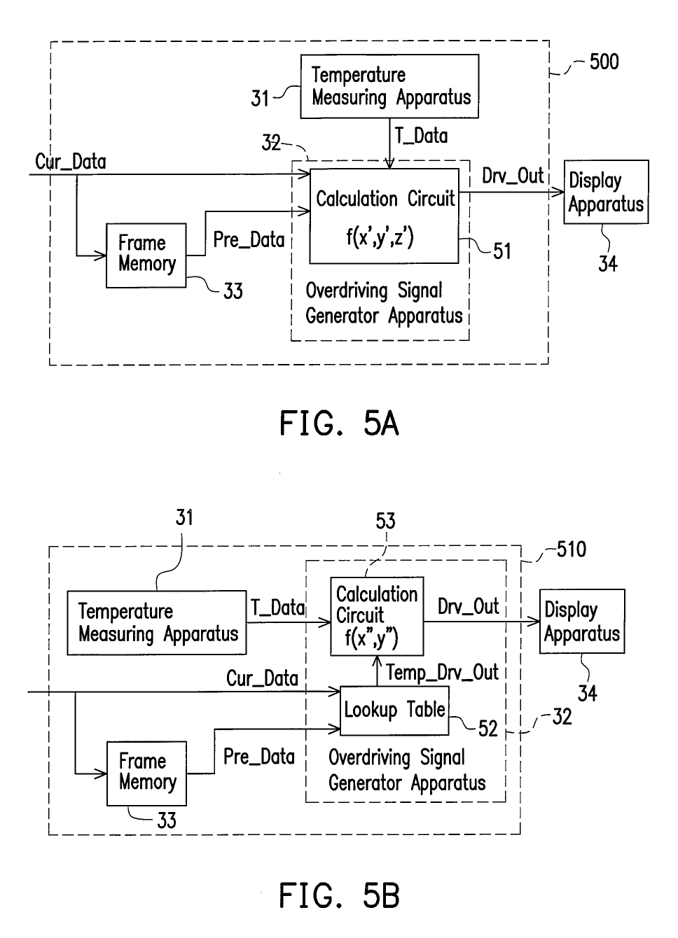

FIG. 5A is a circuit diagram of an overdriving apparatus 500 according to an embodiment of the present invention. Referring to FIG. 5A, in the present embodiment, x=1, and the overdriving signal generator apparatus 32 includes a calculation circuit 51. The calculation circuit 51 is a function calculation circuit for outputting a function f(x′,y′, z′) according to inputs x′, y′, and z′, in which x′, y′, and z′ respectively represent the first image data Cur_Data, the second image data Pre_Data, and the operation temperature T_Data, and f(x′,y′,z′) represents the first overdriving signal Drv_Out.

It should be noted that the function f(x′, y′, z′) could be established when an approximate mathematic relation equation between the first image data Cur_Data, the second image data Pre_Data, the operation temperature T_Data and the first overdriving signal Drv_Out is pre-determined or measured.

FIG. 5B is a circuit diagram of an overdriving apparatus 510 according to an embodiment of the present invention. Referring to FIG. 5B, in the present embodiment, x=1, and the overdriving signal generator apparatus 32 includes a calculation circuit 53 and a lookup table 52. The lookup table 52 is coupled with the calculation circuit 53. The lookup table 52 records a correlation between the first image data Cur_Data, the second image data Pre_Data, and a second overdriving signal Temp_Drv_Out, corresponding to a particular operation temperature. The second overdriving signal Temp_Drv_Out can be obtained by looking up the lookup table 52 according to the first image data Cur_Data and the second image data Pre_Data, in which the second overdriving signal Temp_Drv_Out is an overdriving signal corresponding to a particular operation temperature, e.g., 0° C.

The calculation circuit 53 is a function calculation circuit for outputting a function f(x″, y″) according to inputs x″, y″, in which x″, y″ respectively represent the second overdriving signal Temp_Drv_Out, and the operation temperature T_Data, and f(x″, y″) represents the first overdriving signal Drv_Out. It should be noted that the function f(x″, y″) could be well established in advance when an approximate mathematic relation equation between the second overdriving signal Temp_Drv_Out, and the operation temperature T_Data is pre-determined or measured.

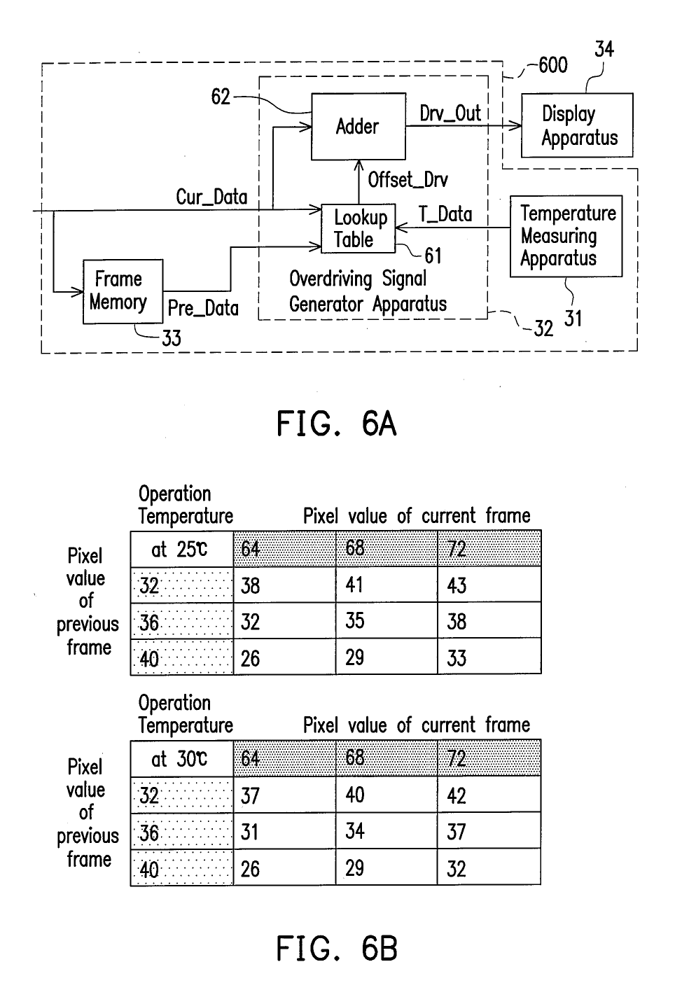

FIG. 6A is a circuit diagram of an overdriving apparatus 600 according to an embodiment of the present invention. Referring to FIG. 6A, in the present embodiment, x=1, and the overdriving signal generator apparatus 32 includes an adder 62 and a lookup table 61. The lookup table 61 records a correlation between the operation temperature T_Data, the first image data Cur_Data, the second image data Pre_Data, and an overdriving compensation signal Offset_Drv. The overdriving compensation signal Offset_Drv can be obtained by looking up the lookup table 61 according to the operation temperature T_Data, the first image data Cur_Data, and the second image data Pre_Data. The adder 62 is coupled to the lookup table 61, for adding the first image data Cur_Data with the overdriving compensation signal Offset_Drv to obtain the first overdriving signal Drv_Out.

FIG. 6B shows a part of content of a lookup table 61 of the overdriving signal generator 32. Referring to FIG. 6B, if the pixel values of the first image data Cur_Data and the second image data Pre_Data are 68 and 36 respectively, and the operation temperature T_Data is 25° C., then the overdriving compensation signal Offset_Drv is 35, and the first overdriving signal Drv_Out=35+36=71.

If the pixel values of the first image data Cur_Data and the second image data Pre_Data are 72 and 32 respectively, and the operation temperature T_Data is 27.5° C., then the overdriving compensation signal Offset_Drv can be obtained by interpolation in temperature. At first, an overdriving compensation signal Offset_{—}1=43 is calculated according to the pixel values of the first image data Cur_Data and the second image data Pre_Data which are 72 and 32 respectively, and the operation temperature T_Data which is 25° C. Then, an overdriving compensation signal Offset_{—}2=42 is calculated according to the pixel values of the first image data Cur_Data and the second image data Pre_Data which are 72 and 32 respectively, and the operation temperature T_Data which is 30° C. Finally, the overdriving compensation signal Offset_{—}1 and Offset_{—}2 are used for calculating the overdriving compensation signal Offset_Drv corresponding to a first image data and a second image data having pixel values of 72, 32 respectively with an operation temperature T_Data of 27.5° C., in which Offset_Drv=(43−42)/5* (27.5−25)+42=42.5. The first overdriving signal Drv_Out=42.5+32=74.5.

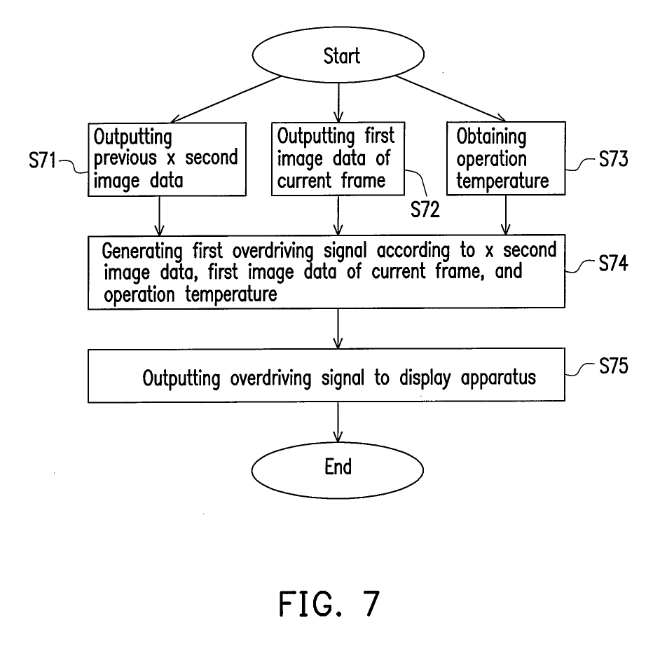

FIG. 7 is a flow chart illustrating an overdriving method according to an embodiment of the present invention. Referring to FIG. 7, at step S72, a first image data of a current frame is received. At step S71, a frame memory outputs x second image data of previous x frame(s). At step S73, a temperature measuring apparatus obtains an operation temperature of the LCD panel. Then at step S74, the overdriving signal generator apparatus generates a first overdriving signal according to the x second image data of the previous x frames, the first image data of the current frame, and the operation temperature. Then at step S75, the first overdriving signal is outputted to the display apparatus. The overdriving method according to the embodiment of the present invention can be but not restricted to the overdriving apparatus of FIG. 4A, 5A, 5B and 6A.

In summary, the overdriving apparatus and the overdriving method according to the present invention take the transmittance variation over the temperature variation into consideration (e.g., the viscosity and the refractive indices of liquid crystal molecules vary according to temperature variation so as to affect a response speed and the transmittance of the liquid crystal molecules) by providing a temperature compensation to the generated overdriving signal. And therefore, the overdriving signal generator apparatus and the overdriving method according to the present invention are adapted to provide better overdriving signals corresponding to different temperatures, which won't be overshoot or undershoot. Comparing with the conventional overdriving apparatus and the overdriving method thereof, an LCD employing the overdriving apparatus and the overdriving method according to the present invention can effectively eliminate the motion blur and double edge defects caused by temperature influence.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An overdriving apparatus adapted for a display panel, comprising:
a temperature measuring apparatus, adapted for measuring an operation temperature of the display panel; and
an overdriving signal generator apparatus, coupled to the temperature measuring apparatus, for generating a first overdriving signal according to a first image data of a current frame, x second image data of previous x frame(s), and the operation temperature, wherein x is a natural number.

2. The overdriving apparatus according to claim 1, further comprising:
a frame memory, coupled to the overdriving signal generator apparatus for storing the x second image data.

3. The overdriving apparatus according to claim 1, wherein the temperature measuring apparatus is a temperature sensor or a temperature estimator, the temperature measuring apparatus being mounted on or close to the display panel.

4. The overdriving apparatus according to claim 3, wherein the temperature estimator is adapted for calculating an operation time of the display panel, and estimating the operation temperature according to the operation time.

5. The overdriving apparatus according to claim 1, wherein the overdriving signal generator apparatus comprises:
a lookup table, adapted for storing a first overdriving signal in response to the first image data, the x second image data, and the operation temperature, wherein the first overdriving signal can be obtained by referring to the lookup table according to the first image data, the x second image data, and the operation temperature.

6. The overdriving apparatus according to claim 1, wherein the overdriving signal generator apparatus comprises:
a calculation circuit, adapted for calculating the first overdriving signal according to the first image data, the x second image data, and the operation temperature.

7. The overdriving apparatus according to claim 1, wherein the overdriving signal generator apparatus further comprises:
a lookup table, adapted for storing a second overdriving signal in response to ,the first image data, and the x second image data, wherein the second overdriving signal can be obtained by referring to the lookup table according to the first image data, and the x second image data; and
a calculation circuit, coupled to the lookup table, for calculating the first overdriving signal according to the second overdriving signal and the operation temperature.

8. The overdriving apparatus according to claim 1, wherein the overdriving signal generator apparatus further comprises:
a lookup table, adapted for storing an overdriving compensation signal in response to the first image data, the x second image data, the operation temperature, and 1, and for finding out the overdriving compensation signal according to the first image data, the x second image data, and the operation temperature; and
an adder, coupled to the lookup table, for adding the overdriving compensation signal to the first image data to obtain the first overdriving signal.

9. An overdriving method, adapted for a display panel, comprising:
measuring an operation temperature of the display panel; and
generating a first overdriving signal according to a first image data of a current frame, x second image data of previous x frame(s), and the operation temperature, wherein x is a natural number.

10. The overdriving method according to claim 9, further comprising:
storing the x second image data.

11. The overdriving method according to claim 9, wherein the operation temperature of the display panel is obtained by measuring with a temperature sensor or a temperature estimator which is mounted on or close to the display panel.

12. The overdriving method according to claim 11, wherein the temperature estimator is adapted for calculating an operation time of the display panel, and estimating the operation temperature according to the operation time.

13. The overdriving method according to claim 9, wherein the step of generating the first overdriving signal comprises:
providing a lookup table, which storing the first overdriving signal in response to the first image data, the x second image data, and the operation temperature; and
referring to the lookup table to find out the first overdriving signal.

14. The overdriving method according to claim 9, wherein the step of generating the first overdriving signal comprises:
providing a calculation circuit, for obtaining the first overdriving signal by calculating with the first image data, the x second image data, and the operation temperature.

15. The overdriving method according to claim 9, wherein the step of generating the first overdriving signal comprises:
providing a lookup table, which is adapted for storing a second overdriving signal in response to the first image data, and the x second image data;
looking up the lookup table to find out the second overdriving signal; and
providing a calculation circuit, for calculating the first overdriving signal according to the second overdriving signal and the operation temperature.

16. The overdriving method according to claim 9, wherein the step of generating the first overdriving signal comprises:
providing a lookup table, which is adapted for storing an overdriving compensation signal in response to the first image data, the x second image data, and the operation temperature;
finding out the overdriving compensation signal according to the first image data, the x second image data, and the operation temperature; and
adding the overdriving compensation signal to the first image data to obtain the first overdriving signal.
